(19) United States
(12) Patent Application Publication
(10) Pub. No.: US 2005/0264522 A1
(43) Pub. Date: Dec. 1, 2005

(54) Data input device

(75) Inventors: Tsuyoshi Abe, Tokyo (JP); Hitoshi Yasui, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: YOKOGAWA ELECTRIC CORPORATION, Musashino-shi (JP)

(21) Appl. No.: 11/080,655

(22) Filed: Mar. 16, 2005

(30) Foreign Application Priority Data
May 28, 2004 (JP) 2004-158665

(51) Int. Cl. G09G 5/00

(52) U.S. Cl. 345/156

(57) ABSTRACT

An input device that performs an input operation to an information technology device such as a computer is provided. The input device has a switch arranged at a finger part of a hand and for outputting a signal corresponding to a pressing operation, and a position detecting unit for detecting a movement of the hand and outputting a detection signal. Thus, as a movement of the hand is associated with a movement of a cursor and an operation of a finger of the hand is associated with an operation of click button, it is possible to realize a data input device that has a simple structure, enables simple operation and can be easily used.

### BACKGROUND OF THE INVENTION

1. Field of the Invention

This invention relates to an input device that performs an input operation to an information technology device such as a computer.

2. Description of the Related Art

Generally, a mouse and a track ball are known as input devices that provide data to a computer.

A mouse or track ball detects the distance and direction of movement from the quantity and direction of rotation of a sphere. With the mouse or track ball, necessary data and commands are inputted by freely moving a cursor on a display and operating a click button.

As an input device that provides data through more natural movement of a human, a glove-type input device is known.

In a glove-type input device, a contact detecting unit for detecting the existence of contact is provided at a predetermined part on a glove. The state of a hand is discriminated from a signal acquired from this contact detecting unit, and a character or the like corresponding to state of the hand is inputted.

Glove-type input devices are described, for example, in Patent Reference 1 and Patent Reference 2.

Patent Reference 1: JP-A-2003-177863

Patent Reference 2: JP-A-2003-15810

However, the conventional examples have the following problems.

In the case of a mouse, the place where it can be used is limited a flat working surface because it detects the distance and direction of movement from the quantity and direction of rotation of a sphere.

Moreover, since a keyboard and a mouse are physically separated from each other, individual places for installing the keyboard and the mouse are necessary and a user must move his/her hand between the keyboard and the mouse when operating these. This causes a problem of lowering of the operating efficiency.

In a so-called presentation where a display screen of a display of a personal computer or the like is projected in an enlarged form and a presenter gives an explanation or the like of the display content while showing the enlarged projected display screen to many people, a mouse or track ball is operated to move a cursor displayed on the display screen and to indicate a certain part of the display image displayed on the display screen or change the display screen to another display content by using a click button.

In this case, there is a problem that when a person who explains the display image displayed on the display screen is different from an operator who operates the mouse or track ball, the person who gives the explanation cannot freely change the display screen to another display content as this person intends.

Meanwhile, the use of a glove-type input device utilizing virtual reality enables operation equivalent to that of a mouse, but there is a problem that its structure is too complicated.

### SUMMARY OF THE INVENTION

In view of the foregoing problems, it is an object of this invention to realize a data input device that can easily implement, through movements of a hand, the functions equivalent to those of a mouse for performing an input operation to an information technology device such as a computer.

### BRIEF DESCRIPTION OF THE DRAWINGS

FIG. 1 is a structural view showing an embodiment of this invention.

FIG. 2 is a view showing a state of use of this invention.

FIGS. 3A and 3B are structural views showing another embodiment of this invention.

FIG. 4 is a structural view showing another embodiment of this invention.

FIG. 5 is a conceptual view showing another embodiment of this invention.

### DETAILED DESCRIPTION OF THE PREFERRED EMBODIMENTS

Hereinafter, this invention will be described in detail with reference to the drawings.

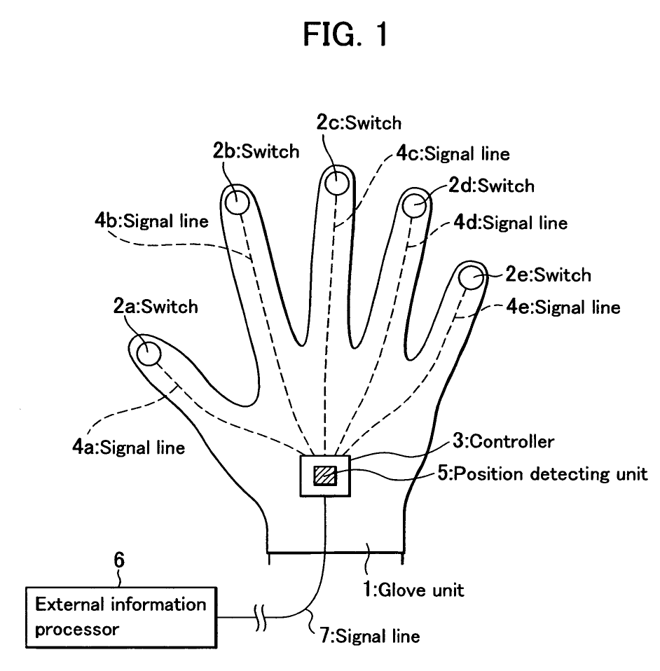

FIG. 1 is a structural view showing an embodiment of this invention.

In FIG. 1, switches 2a to 2e are mounted on the nail side of individual fingers of a glove unit 1, and a controller 3 is mounted on the back of the hand of the glove unit 1.

The switches 2a to 2e and the controller 3 are connected with each other by signal lines 4a to 4e.

The switches 2a to 2e output signals corresponding to pressing operations and their states are transmitted to the controller 3 through the signal lines 4a to 4e.

A position detecting unit 5 is mounted in the controller 3.

As the position detecting unit 5, for example, a unit for detecting an absolute position by using a position sensor, a unit for detecting a change in relative distance by using an acceleration sensor or the like is used.

The position detecting unit 5 detects a movement of a hand and transmits a detection signal to the controller 3.

The controller 3 has a communication interface (not shown) and outputs the signals corresponding to the pressing operations of the switches 2a to 2e and the detection signal from the position detecting unit 5. An external information processor 6 can acquire the output of the controller 3 through a signal line 7.

Instead of the communication through the signal line 7, wireless communication may be used.

In the external information processor 6, the movement of the hand can be associated with the movement of a cursor, and the movement of the fingers of the hand can be associated with the operation of a click button. In this manner, the functions equivalent to those of a mouse are realized.

The external information processor 6 can separately acquire the states of the switches 2a to 2e and the position information from the position detecting unit 5, and can discriminate how much and which direction the hand has moved in the state where the switch (or switches) is pressed.

Since the switches 2a to 2e are mounted on the nail side of the fingers of the glove unit 1, the switches 2a to 2e do not malfunction even when the operator performs a keyboard operation.

Moreover, the operator can perform the pressing operation of the switches 2a to 2e while holding an object in the hand. This data input device does not require a flat working surface and it is effective in various fields such as confirmation of production status at a production site as well as changes of the display screen in the case of presentation.

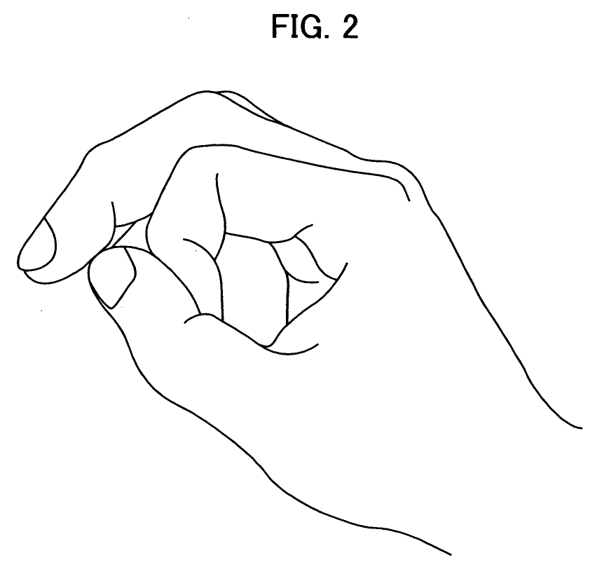

FIG. 2 is a view showing a state of use of this invention. To facilitate understanding of the state of the hand, only the state of the hand in the glove is shown.

In FIG. 2, the nail of the forefinger of the right hand is pressed by the palm side of the thumb. This is a state where the switch 2b of FIG. 1 is pressed.

For example, in the case where a left click button of the mouse is allocated to the switch 2b of FIG. 1 and a right click button of the mouse is allocated to the switch 2c, an operation of the left click button of the mouse can be realized in the state of FIG. 2.

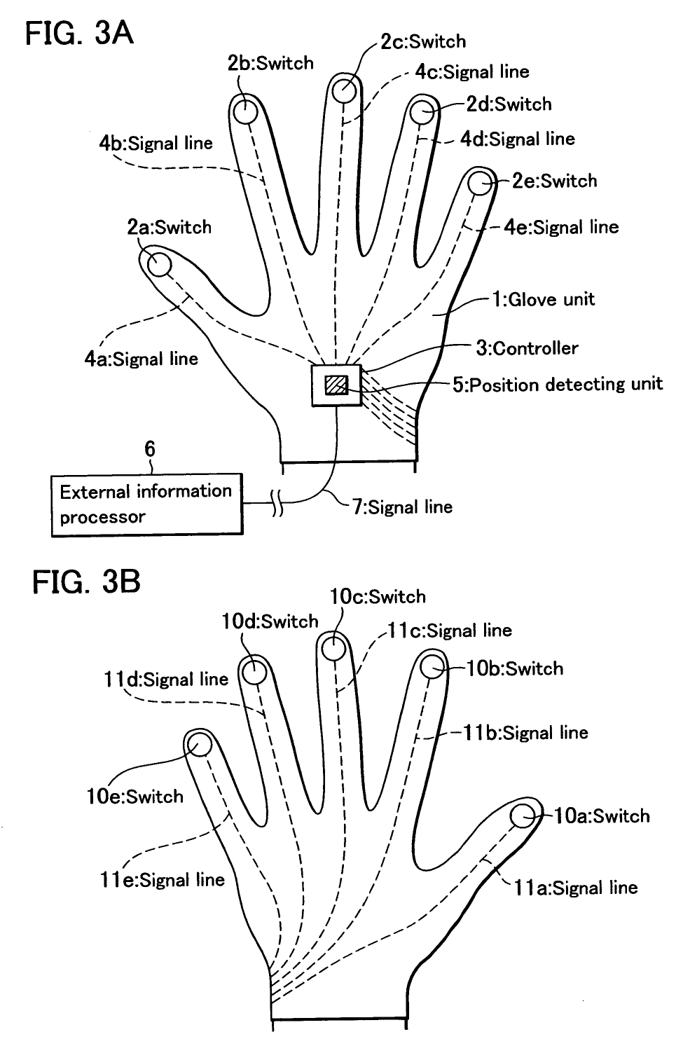

FIGS. 3A and 3B are structural views showing another embodiment of this invention. FIG. 3A is a view as seen from the back side of the hand. FIG. 3B is a view as seen from the palm side.

In FIGS. 3A and 3B, switches 2a to 2e are mounted on the nail side of the fingers and switches 10a to 10e are mounted on the palm side of the fingers.

As the switches 10a to 10e are additionally provided on the palm side of the fingers, the functions of the data input device can be allocated by combining these switches 10a to 10e with the switches 2a to 2e on the nail side of the fingers. Therefore, more functions can be realized than in the case where the switches are mounted only on the nail side of the fingers.

In this embodiment, since the switches 10a to 10e are provided on the palm side of the fingers, the switches are pressed when the operator performs a keyboard operation or the like. However, the malfunctions can be canceled by combining the switches on the two sides to allocate the functions of the data input device.

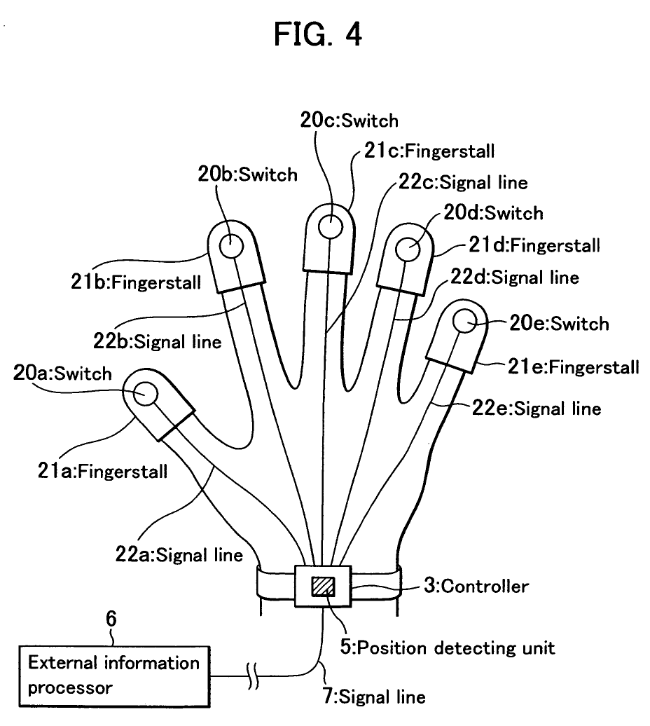

FIG. 4 is a structural view showing another embodiment of this invention.

In FIG. 4, switches 20a to 20e are mounted on the nail side of fingerstalls 21a to 21e.

A controller 3 is mounted at an arm part in the form of a wristwatch. The switches 20a to 20e and the controller 3 are connected with each other by signal lines 22a to 22e.

In this case, since the individual fingers can be fitted into the fingerstalls 21a to 21e, both a right-handed user and a left-handed user can commonly use this device.

In the case where the switches 20a to 20e and the controller 3 are connected not by the signal lines 22a to 22e but by wireless connection, the user can fit his/her finger(s) that can easily operate into only the necessary one(s) of the fingerstalls 21a to 21e. This can improve the operability.

The switches may be affixed directly to the finger parts of the hand by tapes, seals or the like. The places where the switches are mounted and the number of switches to be mounted can be freely selected dependingon the functions to be realized as the data input device, for example, switches mounted on the lateral sides of the fingers (between the nail side and the palm side), switches mounted only on a part of the fingers, switches mounted only on one hand, switches mounted on both hands, and so on.

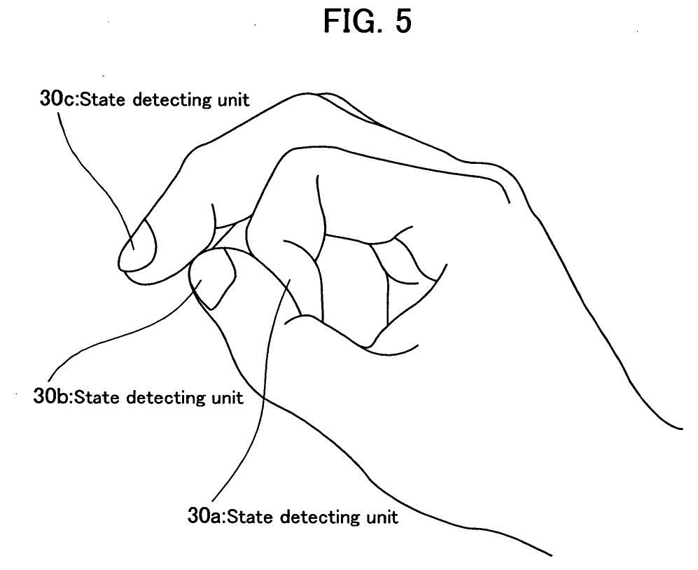

FIG. 5 is a conceptual view showing another embodiment of this invention. To facilitate understanding of this invention, only the state of main constituent elements is shown.

In FIG. 5, the nail of the forefinger of the right hand is pressed by the palm side of the thumb. This is a state where the switch 2b of FIG. 1 is pressed.

In this case, state detecting units 30a to 30e (with 30d and 30e being not shown) are arranged at individual finger parts of the hand and detect the positions of the individual fingers. In the example shown in FIG. 5, from the positional relation of the state detecting units 30a and 30b, it can be discriminated that the switch 2b of FIG. 1 is pressed.

As the state detecting units 30a to 30e, for example, a unit for detecting an absolute position by using a position sensor, a unit for detecting a change in relative distance by using an acceleration sensor or the like is used.

This invention has the following effects.

(1) Since the device is used as the glove is put on the hand, no place for installing the mouse is necessary.

(2) As moving a hand between the keyboard and the mouse is no longer necessary, the functions equivalent to those of the mouse can be realized by operating the hand on the keyboard and the operation efficiency can be improved.

(3) Since the device is used as the glove is put on the hand, no flat working surface is necessary and the working place is not limited. Since the user can operate the device through natural movements, the device is suitable for use in a presentation and the user can perform an operation such as freely changing the display screen to another display content as the user intends.

(4) Since the movement of the hand is associated with the movement of the cursor and the operation of the fingers of the hand are associated with the operations of the click buttons, it is possible to realize a data input device that has a simple structure, enables simple operations and can be easily used.

1. A data input device comprising:
a switch arranged at a finger part of a hand and for outputting a signal corresponding to a pressing operation; and
a position detecting unit for detecting a movement of the hand and outputting a detection signal.

2. The data input device as claimed in claim 1, wherein the switch is arranged on a nail side of a finger.

3. The data input device as claimed in claim 1, wherein the switch is arranged on a nail side and a palm side of a finger.

4. A data input device comprising:
a state detecting unit arranged at a finger part of a hand and for detecting a state of a finger from a position of each finger and outputting a signal corresponding the state of the finger; and
a position detecting unit for detecting a movement of the hand and outputting a detection signal.

5. The data input device as claimed in one of claims 1 to 4, wherein the position detecting unit detects an absolute position by using a position sensor.

6. The data input device as claimed in one of claims 1 to 4, wherein the position detecting unit detects a change in relative distance by using an acceleration sensor.

7. The data input device as claimed in one of claims 1 to 4, wherein the switch or the state detecting unit is mounted on a fingerstall.

8. The data input device as claimed in one of claims 1 to 4, wherein the switch or the state detecting unit is directly affixed to a finger.

9. The data input device as claimed in one of claims 1 to 4, wherein the position detecting unit is affixed directly to an arm.

10. The data input device as claimed in one of claims 1 to 4, wherein the switch or the state detecting unit, and the position detecting unit are mounted on a glove unit.
